(19) United States
(12) Patent Application Publication
(10) Pub. No.: US 2009/0250240 A1
(43) Pub. Date: Oct. 8, 2009

(54) EASILY STRIPPABLE ELECTRIC CABLE

(76) Inventors: Arnaud Piechaczyk, Paris (FR); Olivier Schuepbach, Paris (FR); Philippe Bras Pereira, Paris (FR)

Correspondence Address: SOFER & HAROUN LLP., 317 MADISON AVENUE, SUITE 910, NEW YORK, NY, 10017, US

(21) Appl. No.: 12/369,888

(22) Filed: Feb. 12, 2009

(30) Foreign Application Priority Data
Feb. 15, 2008 (FR) 08 50967

(51) Int. Cl. H01B 7/17

(52) U.S. Cl. 174/110 R

(57) ABSTRACT

The present invention relates to an electric cable comprising one or more insulated electrical conductors forming a set of insulating conductors extending longitudinally inside a protective sheath, the inside surface of said protective sheath having at least two longitudinal grooves for the purpose of enabling the protective sheath to be stripped, wherein the outside surface of the protective sheath does not include longitudinal grooves for constituting tear starters of the protective sheath, and wherein the longitudinal grooves in the inside surface of the protective sheath are disposed at substantially equal distances from each other or from one another.

### RELATED APPLICATION

This application claims the benefit of priority from French Patent Application No. 08 50967, filed on Feb. 15, 2008, the entirety of which is incorporated by reference.

### FIELD OF THE INVENTION

The present invention relates to an electric cable. It applies typically but not exclusively to the fields of electric power cables and/or telecommunications cables.

### BACKGROUND OF THE INVENTION

Document FR 2 706 068 discloses an electric cable that is easily strippable without using a special tool adapted for that purpose.

That electric cable comprises a set of insulated electrical conductors surrounded by a protective sheath. Said protective sheath presents firstly, on its outside surface both external longitudinal ribs and external longitudinal grooves, and in its inside surface internal longitudinal grooves.

More particularly, each pair of external longitudinal grooves constitutes a tear starter for the protective sheath.

The outer longitudinal ribs are centered between each pair of outer longitudinal grooves, thereby making it possible to grasp and pull on the protective sheath.

In order to make it easier to strip the protective sheath, the internal longitudinal grooves are placed in register with the external longitudinal grooves.

Nevertheless, the external longitudinal grooves of the electric cable constitute zones where elements from the environment of said protective sheath can accumulate and become attached, such as for example oil, water, bacteria, . . . .

These elements that accumulate in such accumulation zones thus tend to degrade the integrity of the physiochemical properties of the protective sheath, thereby degrading the integrity of the electrical conductors insulated inside said protective sheath.

### OBJECT AND SUMMARY OF THE INVENTION

The present invention proposes an electric cable that sets out to mitigate the above-mentioned drawbacks, while being easily strippable.

The solution of the present invention is to propose an electric cable comprising one or more insulated electrical conductors forming a set of insulating conductors extending longitudinally inside a protective sheath, the inside surface of said protective sheath having at least two longitudinal grooves for the purpose of enabling the protective sheath to be stripped, wherein the outside surface of the protective sheath does not include longitudinal grooves for constituting tear starters of the protective sheath, and wherein the longitudinal grooves in the inside surface of the protective sheath are disposed at substantially equal distances from each other (when the inside surface of the protective sheath has two longitudinal grooves) or from one another (when the inside surface of the protective sheath has at least three longitudinal grooves).

Thus, the outside surface of the protective sheath of said cable of the present invention presents good tribological performance, and thus good sliding properties so as to avoid creating zones where elements from the environment of said cable can accumulate and become attached.

Furthermore, the absence of longitudinal grooves in the outside surface of the protective sheath has the advantage of not weakening said surface.

Finally, because the longitudinal grooves are regularly distributed in the inside surface of the protective sheath, the protective sheath is easily stripped or torn, in particular by hand, regardless of where stripping is started.

The term “groove” is used to mean a zone of weakness, or notch, serving to cause the protective sheath to tear or split, thereby enabling it to be stripped.

Preferably, the inside surface of the protective sheath may include at least three longitudinal grooves.

Furthermore, in a particular embodiment, the outside surface of the protective sheath may be substantially smooth and uniform. Advantageously said outside surface thus has substantially no accumulation zone.

By way of example, the outside surface of the protective sheath does not have longitudinal ribs such as a relatively narrow shoulder, serving to grasp and pull on the protective sheath, as defined in document FR 2 706 068.

In order to make the protective sheath easier to strip manually, the stripping force may be no more than 50 newtons (N), and preferably no more than 20 N.

Advantageously, the protective sheath may have a breaking stress of at least 5 megapascals (MPa), and preferably at least 10 MPa. The breaking stress is conventionally determined in compliance with IEC standard 60811.

Furthermore, the protective sheath may also present elongation at break of at least 50%, and preferably of at least 150%. Elongation at break is conventionally determined in compliance with IEC standard 60811.

In a particular embodiment, the longitudinal grooves in the inside surface of the protective sheath may advantageously be identical in shape.

In another embodiment, the inside surface of the protective sheath has at least one longitudinal groove obtained from a notch of V-shaped cross-section with the middle axis thereof being preferably radial relative to the electric cable. Preferably, each of the longitudinal grooves is obtained from a notch of V-shaped cross-section, each notch having its middle axis that is preferably radial relative to the electric cable.

In another embodiment, the inside surface of the protective sheath has at least one longitudinal groove obtained from a notch of cross-section that is U-shaped or rectangular, with its middle axis preferably being radial relative to the electric cable. Preferably, each of the longitudinal grooves is obtained from a notch of cross-section that is U-shaped or rectangular, with its middle axis being preferably radial relative to the electric cable.

In various embodiments, the protective sheath in accordance with the present invention may be a tube sheath, a semi-tube sheath, or a packed sheath.

### BRIEF DESCRIPTION OF THE DRAWINGS

Other characteristics and advantages of the present invention appear in the light of examples given below with reference to the annotated figures, said examples and figures being given by way of non-limiting illustration.

FIG. 1 is a diagrammatic cross-section view of an electric cable with a “packed” protective sheath, in accordance with the invention.

FIG. 2 is a diagrammatic cross-section view of an electric cable with a “semi-tube” protective sheath, in accordance with the invention.

FIG. 3 is a diagrammatic cross-section view of an electric cable with a “tube” protective sheath, in accordance with the invention.

For reasons of clarity, elements that are the same are designated by identical references. Similarly, only those elements that are essential for understanding the invention are shown, and they are shown diagrammatically without being to scale.

### MORE DETAILED DESCRIPTION

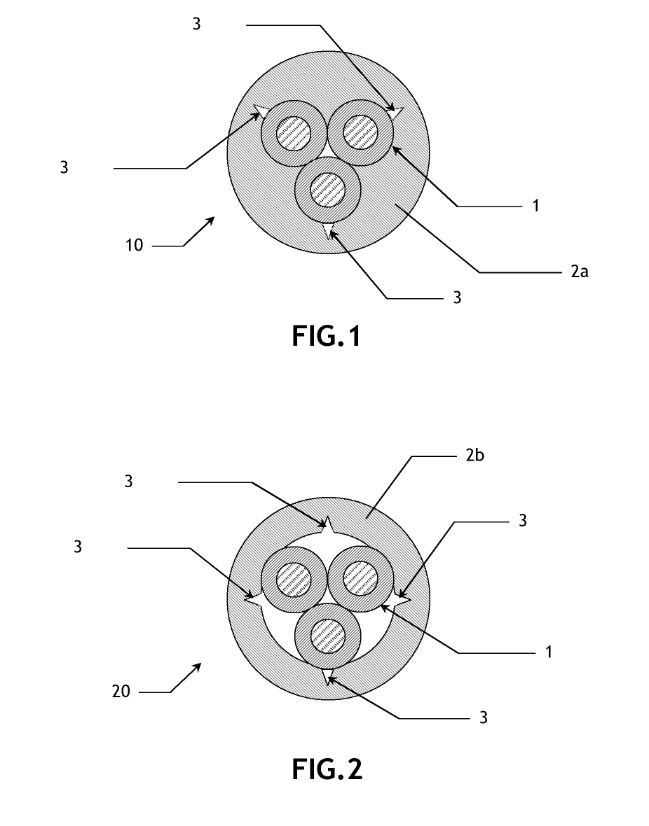

As shown in FIG. 1, an electric cable 10 of substantially circular section comprises a set of three insulated electrical conductors 1, that are preferably twisted together, surrounded by a protective sheath 2a.

On its inside surface, the protective sheath 2a has three V-shaped continuous longitudinal grooves 3 in the thickness of said sheath, these three grooves being placed at intervals of about 120° from one another. These grooves 3 thus constitute tear starters for stripping the protective sheath.

This grooved protective sheath 2a shown diagrammatically in FIG. 1 is said to be “packed”. It is obtained by a continuous extrusion method that is well known to the person skilled in the art, using a polymer composition in such a manner that said composition fills the interstices between the insulated electrical conductors 1 wherever the volumes of said interstices are accessible. The pressure at the outlet from the extruder that is required for obtaining said packed sheath acts to compress the notches of V-shaped cross-section, and it can thus be difficult to visualize them as such when looking at a cut end of the electric cable.

By way of example, the polymer composition is of the halogen free flame retardant (HFFR) type based on polyolefin.

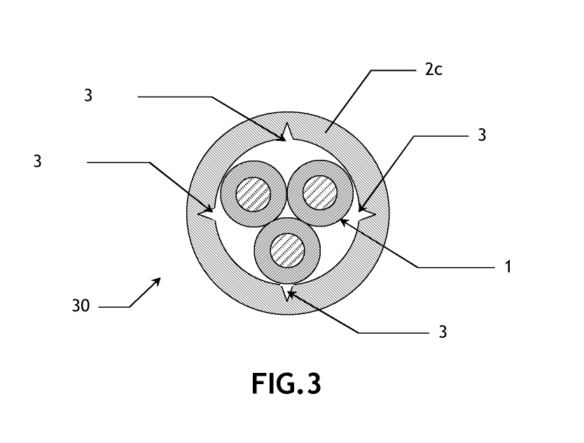

FIG. 2 and FIG. 3 show respectively an electric cable 20 and an electric cable 30 both of substantially circular section and each comprising a set of three, preferably twisted-together, insulated electrical conductors 1, surrounded by respective protective sheaths 2b or 2c.

On their inside surfaces, the protective sheaths 2b and 2c have four V-shaped continuous longitudinal grooves 3 in the thickness of the sheath, in accordance with the present invention. These four grooves are placed at about 90° from one another.

The protective sheath 2b shown in FIG. 2 is said to be a “semi-tube” sheath, while the protective sheath 2c shown in FIG. 3 is said to be a “tube” sheath.

The semi-tube sheath 2b is a sheath that is said to be “tight” around the set of insulated conductors 1, thereby preventing the set of said insulating conductors from moving inside said sheath.

The tube sheath 2c is a sheath that leaves the insulated electrical conductors free inside said sheath.

The tube sheath is very simple and quick to make since the pressure it requires at the outlet from the extruder is smaller than that needed for fabricating packed and semi-tube sheaths.

The grooved protective sheaths 2b and 2c are likewise obtained by a continuous extrusion method well known to the person skilled in the art using a polymer composition of the HFFR type based on polyolefin.

In a particularly advantageous embodiment, as shown in FIGS. 1 to 3, the protective sheaths 2a, 2b, and 2c surround the insulated electrical conductors 1 directly.

In this sense, “directly” means that the electric cable does not include any slip-enhancing material, such as talc for example, between the insulated conductors and the inside surface of the protective sheath.

The protective sheath of the present invention is easily torn, so a slip agent for causing the protective sheath to slide on the insulated electrical conductors is not needed in order to gain access to said conductors.

In order to demonstrate the ease with which the protective sheath of an electric cable of the present invention can be stripped, a stripping test has been performed on electric cables of the invention having an outside diameter of about 8 millimeters (mm).

The electric cables included respective extruded protective sheaths, each having a thickness of 1 mm and obtained from an HFFR polymer composition comprising a polyolefin matrix and fire-retardant fillers.

Said protective sheaths had one, two, or four V-shaped internal longitudinal grooves (notches) with a radial depth equal to about half the thickness of the protective sheath, i.e. about 0.5 mm, in particular for a conventional low-voltage cable sheath for use in buildings.

Each protective sheath directly surrounded a twisted set of three insulated copper conductors, each copper conductor having a section of 1.5 square millimeters (mm²).

The tests took-account of the natures of the protective sheaths, i.e. whether they were packed sheaths, semi-tube sheaths, or tube sheaths.

The equipment used for carrying out the stripping test was a Zwick single-axis traction machine with two self-clamping chucks, one of the chucks being stationary and the other movable on a cross-member. The two chucks were placed facing each other and they were initially spaced apart by 45 mm. The travel speed of the cross-member was 50 millimeters per minute (mm/min). A segment of electric cable as defined above having a length of about 100 mm was placed between the two chucks as explained below.

For the electric cables having a protective sheath with a single internal notch, one end of the electric cable was held in the stationary chuck. Close to the chuck, a copper hook was inserted in the notch, the hook itself being held in the other chuck, and then traction was applied to the hook.

For electric cables having a protective sheath with two internal notches spaced apart at 30° from each other, the end of the strip of the protective sheath defined by those two notches was held in the stationary chuck while the end of the other portion of the protective sheath was held in the other chuck. Traction was then applied to the strip formed by opening the two notches. This stripping test was also performed on electric cables having a protective sheath with two internal notches spaced apart at 180° from each other.

For electric cables having a protective sheath with four notches placed at 90° from one another, the procedure was as above. Firstly, the end of the strip of protective sheath defined by two notches spaced apart by about at 180° was held in the stationary chuck, and secondly the end of the other portion of the protective sheath was held in the other chuck. Traction was then applied to the strip formed by opening the two notches.

The striping force was measured by a sensor. In all of the tests, regardless of whether the protective sheath was a packed sheath, a semi-tube sheath, or a tube sheath, in combination with one, two, or four notches, the stripping force rose and then stabilized at a plateau having a value of about 10 N.

This value of 10 N is taken as the stripping force and corresponds approximately to hanging a weight of 1 kilogram (kg) on the notches in order to strip the protective sheath of an electric cable in accordance with the invention.

The stripping force as obtained in this way is of the same order of magnitude as that needed for stripping the protective sheath from the electric cable of document FR 2 706 068.

The protective sheath can thus be stripped manually, without help from a special tool that might damage the insulated electrical conductors of said cable while it is being stripped.

Naturally, the polymer composition used and also the depth, the positioning, the shape, and the number of the internal longitudinal grooves in the protective sheath used in the tests are given purely by way of non-limiting illustration.

In particular, the more rigid the protective sheath, in other words the greater its breaking stress, the easier the protective sheath is to strip with a stripping force of less than 50 N, and preferably less than 20 N.

Similarly, the greater the number of internal longitudinal grooves, and likewise the greater their depth in the thickness of the protective sheath, the easier the protective sheath is to strip with a stripping force of less than 50 N, and preferably less than 20 N.

Optimizing the stripping force as a function of the rigidity of the protective sheath, the number of internal longitudinal grooves, and the depth of said grooves in the thickness of the protective sheath can easily be performed by routine testing.

Stripping the electric cable of the present invention can be performed by cutting through the thickness of the protective sheath in order to gain access to the electrical conductors, or more particularly by cutting right through the electric cable, and then manually stripping said sheath in order to gain access to the insulated electrical conductors so as to be able to connect them subsequently.

What is claimed is:

1. An electric cable comprising:
one or more insulated electrical conductors forming a set of insulating conductors extending longitudinally inside a protective sheath, the inside surface of said protective sheath having at least two longitudinal grooves for the purpose of enabling the protective sheath to be stripped, wherein the outside surface of the protective sheath does not include longitudinal grooves for constituting tear starters of the protective sheath, and wherein the longitudinal grooves in the inside surface of the protective sheath are disposed at substantially equal distances from each other or from one another.

2. The electric cable according to claim 1, wherein the inside surface of the protective sheath includes at least three longitudinal grooves.

3. The electric cable according to claim 1, wherein the outside surface of the protective sheath is substantially smooth and uniform.

4. The electric cable according to claim 1, wherein the stripping force is no more than 50 N, and preferably no more than 20 N.

5. The electric cable according to claim 1, wherein the protective sheath has a breaking stress of at least 5 MPa, and preferably at least 10 MPa.

6. The electric cable according to claim 1, wherein the protective sheath presents elongation at break of at least 50%, and preferably of at least 150%.

7. The electric cable according to claim 1, wherein the longitudinal grooves in the inside surface of the protective sheath are identical in shape.

8. The electric cable according to claim 1, wherein the protective sheath is a tube sheath, a semi-tube sheath, or a packed sheath.
